(19) United States
(12) Patent Application Publication
(10) Pub. No.: US 2006/0055704 A1
(43) Pub. Date: Mar. 16, 2006

(54) Empty space reduction for auto-generated drawings

(76) Inventors: James L. Kruk, Huntley, IL (US); R. Scott Lambert, Buffalo Grove, IL (US); Brian Gillespie, Byron Center, MI (US); Toby W. Lange, Crystal Lake, IL (US); Thomas E. Johanson, Palatine, IL (US); James K. Pecoraro, Arlington Heights, IL (US); Joseph Whitehead, Palatine, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/082,569

(22) Filed: Mar. 17, 2005

Related U.S. Application Data
(60) Provisional application No. 60/608,968, filed on Sep. 10, 2004.

(51) Int. Cl. G06F 19/00; G05B 15/00

(52) U.S. Cl. 345/581; 700/83; 700/182; 716/1

(57) ABSTRACT

During the dynamic generation of an auto-generated schematic, an arrangement of groupings on a page is controlled to minimize white space between on a page. The white space is compressed to minimize the number of pages for a schematic drawing having multiple pages. The compression process ensures that the coordinates generated by a compression process fall on the snap grid of an auto-generated drawing.

### PRIORITY AND CROSS-REFERENCE TO RELATED APPLICATION

This is application claims priority under 35 U.S.C. §119(e) to co-pending provisional application No. 60/608,968, filed on Sep. 10, 1004, entitled METHOD FOR CONFIGURING A BUILDING CONTROL SYSTEM, and which is incorporated in its entirety herein.

### BACKGROUND

The present invention relates to auto-generated drawings. In particular, a process minimizes white space, or empty space, in a rendered schematic.

Schematic drawings, or system plans, illustrate relationships of components of a system. Automated systems generate schematic drawings to illustrate some, all, or substantially all of the electrical wiring and/or electrical connections between components of a building automation system. The schematic drawing may be used by installers, designers, engineers, architects, planners, and/or estimators to view a designed system.

A computer aided design (CAD) application renders a visual representation of the building automation system and/or portions or aspects of the system. The building automation system may be configured or designed to automate control of building systems and networks such as security, fire and hazard detection and prevention, heating, ventilation, air conditioning (HVAC) or other control systems for buildings. The components of a designed building automation system include controllers, sensors, actuators, chillers, fans, humidifiers, and/or air handling units that are positioned in the building and configured to provide a desired environment for the building or portion thereof. When a building automation system is designed, engineered and/or configured, an electrical schematic may be generated to illustrate the electrical connections and/or coupling between components. The electrical connections may include power and communication connections. The electrical connections may be wired or wireless connections. The schematic drawing may be reviewed by a designer, approved by an architect, and used by an installer to install the components of the building automation system.

A CAD or autoCAD rendered drawing is rendered without respect to space or layout requirements for the drawing. A single page of a schematic drawing may have a large amount of white or empty space between components. As a result, a schematic drawing for a system may have a large or excessive amount of pages. The excessive pages may be costly to prepare, maintain, organize, maintain, and distribute. In addition, since there may be excessive pages, there is a greater likelihood that one or more pages may be displaced. For example, an excessive amount of drawings is undesirable because the pages require extra labor and effort for tracking on an installation site for the system. Manually determining an appropriate spacing for a schematic may be labor intensive, costly and time-consuming.

### BRIEF SUMMARY

By way of introduction, the embodiments described below include methods, processes, apparatuses, and systems for compressing schematic drawings or representations to reduce or minimize empty space in a drawing.

A user interface, such as a system configurator, may be used to design, create, customize and configure systems based on parameters or features of the system. In an example, a configurator guides a user through a selection process where a user may choose or otherwise identify features of a desired system. The configurator identifies and presents proper choices for the features to assist the user in designing a configurable system. When selections are made, the configurator may identify other features, equipment, components, control strategies or other criteria based on the selected features. The configurator identifies some, all, or substantially all components of the system, and a data set representative of the selected components, selected features, equipment, and control strategies is generated and stored.

The configurator may process the data set to identify related components, or groupings. Using a schematic generation engine, such as a CAD or autoCAD system, one or more visual representations, such as electrical schematic drawings of the configured system may be generated to illustrate the groupings. The groupings are configured and/or arranged on the schematic drawing to reduce the number of drawing pages for the system. In particular, the schematic drawings are generated to automatically minimize the number of schematic pages for an accurately and correctly depicted configured building automation system by reducing an amount of empty space between groupings in the schematic drawings.

In a first aspect, a method for generating a schematic drawing is provided. In the method, a data set identifying engineering parameters for components of a configured system is generated. The data set is filtered to identify groupings of associated components. A size of each grouping relative to a schematic drawing page is determined. Based on the size of each grouping, the groupings are arranged on a schematic rendering so that adjacent groupings are separated by a predetermined or maximum spacing. The predetermined spacing may minimize the total number of pages for the configured system. In an exemplary embodiment, the configured system is a building automation system and the schematic drawing is an electrical schematic illustrating the electrical components of the configured building automation system.

In a second aspect, a method for compressing an auto-generated drawing is provided. The method includes populating a database with data associated with parameters for components of a configured system. From the data, groupings of associated components are identified and a layout of the components for each grouping is determined and/or configured. The layout of each grouping is determined according to the parameters for the components of each grouping. For each identified grouping, a size or span of the grouping relative to a schematic page is determined. The groupings are plotted on a page so that each grouping is spaced a maximum distance from an adjacent grouping on the page of a schematic drawing. For example, a first grouping is located on an origin for the page. An adjacent grouping is located and aligned on the page at a position that is a distance away from the origin at least the span of the first grouping and the predetermined spacing. The page is populated with groupings of components where each grouping is located and aligned on the page at a location that is a distance away from the origin that is at least the total of the spans of the groupings previously located on the page and the total of the predetermined spacings between the previously located groupings. The page is populated until it is determined that there is not sufficient space on a page for a grouping, then a new page is rendered.

In a third aspect, a computer-readable medium storing computer-executable instructions that may be executed to direct one or more processors of a digital computing device to generate a schematic diagram for a configured system. The processor is directed to generate a data set associated with parameters for components for a configured system. The data set is filtered to identify groupings of related components of the configured system, and a size of a rendering of each grouping relative to a schematic drawing page is determined. The renderings are arranged on a schematic page according to the determined size of each grouping so that adjacent groupings on the schematic drawing page are separated by a predetermined spacing. The schematic drawing page having a plurality of groupings is rendered by the computing device to illustrate a plurality of groupings.

In a fourth aspect, a method for rendering a schematic representation for a building automation system is provided. In the method, a building automation system to be configured is selected and designed using a configuration engine that is driven according to engineering parameters for the selected building automation system. An electrical schematic of the designed building automation system is generated using the configuration to illustrate electrical components of the configured system. The electrical components are laid out in the electrical schematic according ordered groupings of associated components. The groupings are spaced a predetermined distance and arranged according to the engineering parameters for the selected building automation system.

The present invention is defined by the following claims. Nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components in the figures are not necessarily to scale, emphasis instead being placed upon illustrating the principles of the invention. Moreover, in the figures, like reference numerals designate corresponding parts throughout the different views.

FIG. 1 is a diagrammatic representation for an exemplary configurator;

FIG. 2 is a block diagram of a processor adapted as a building automation system configurator of FIG. 1;

FIG. 3 is a exemplary building automation system designed using the configurator of FIG. 1; and

FIG. 4 illustrates an exemplary compressed schematic that may be generated by a configurator of FIG. 1; and

FIG. 5 illustrates a block diagram flowchart for a method for compressing a schematic drawing.

### DETAILED DESCRIPTION OF THE DRAWINGS AND PRESENTLY PREFERRED EMBODIMENTS

A configurator applies engineering rules to guide a user, such as a system designer, through a selection process to configure a system. The selection process is controlled to provide appropriate choices for components and/or features of the system. When the components and/or features are identified, further components, devices, equipment, features, control systems and criteria are identified according to the selected components and/or features to provide a configured system. An example of a configurator is described in co-pending application Ser. No. 11/051,713, filed on Feb. 4, 2005, entitled BUILDING CONTROL SYSTEM CONFIGURATOR, (attorney docket no. 2004 P 15557 US 01), which is incorporated by reference in its entirety herein. A data set associated with the components, devices, equipment, features, control systems and criteria is populated for the configured system.

The data set is processed by a data processing engine to generate one or more schematic representations of the configured system, its constituent components, and/or aspects of the configured system. The data set for a configured system and schematic drawings may be generated as described in the afore-mentioned U.S. patent application for a BUILDING CONTROL SYSTEM CONFIGURATOR and as described in co-pending application Ser. No. 11/051,712, filed on Feb. 4, 2005, entitled CONFIGURATION OUTPUT SYSTEM, (attorney docket no. 2005 P01573 US), which is also incorporated by reference in its entirety herein. The data processing engine is controlled to minimize the number of pages and/or reduce excess empty space in the schematic drawings. For example, a building automation system configurator may be used to design a building automation system and to provide schematic representations for a designed building automations system. Components are arranged according to groupings of components. The groupings are arranged and/or configured within the schematic drawings to minimize space between groupings.

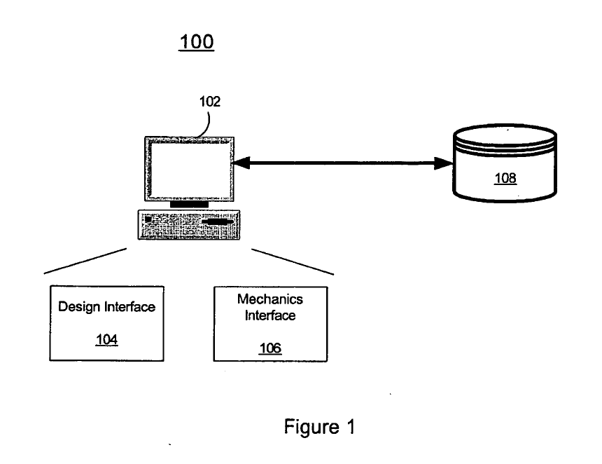

FIG. 1 illustrates a block diagram configurator 100 that may be used to design, and/or configure a system, for example a building automation system. The exemplary configurator 100 includes a data processor 102 operatively coupled to a database 108. Any data processors, computers, databases, data storage, and controller systems such as personal computers, notebook computers, computer networks, workstations, mainframe computers, servers, and the like may be used. The configurator 100 also may be embodied as computer software or firmware including object and/or source code, hardware, or a combination of software and hardware. The configurator 100 may be stored on a computer-readable medium installed on, deployed by, resident on, invoked by and/or used by one or more data processors 102, computers, clients, servers, gateways, or a network of computers, or any combination thereof. The computers, servers, gateways, may have a controller capable of carrying out instructions embodied as computer software. The configurator 100 may be implemented using any known software platform or frameworks including basic, visual basic, C, C+, C++, J2EE™, Oracle 9i, XML, API based designs, and like component-based software platforms. The configurator 100 also may interface with other word processing and graphics software and systems, such as computer-aided drawing systems.

The database 108 includes a single file or a collection of files composed of organized records having one or more fields of data. The data is retrieved and stored in the database 108. The data processor 102 interfaces the database 108 for storage and retrieval of data. Components of the configurator 100 reside in memory and/or storage during operation of the data processor 102. Although shown separately, the database 108 may be a unitary component of the data processor 102. In an embodiment, the database 108 provides storage of data processed by the configurator 100. The data includes information to identify and format a project, such as one or more independent or integrated building control systems. The project information includes, for example, the units of measurement, country for the project, language, project name, company name, customer name, customer contact, division number, address, e-mail, and website, contact information, and/or any other information that may be used to identify a project. The information may be manually input to the configuration, previously stored, or imported to the database. The data also may include information related to the scope of components including control wiring, type, power wiring, interlocks, dampers, smoke detectors, terminal unit controllers, terminal unit actuators, chiller flow switches, boiler flow switches, and the like.

The database 108 also stores data associated with selectable features and components of a building automation system 100. For example, the database stores information associated with components and the relationship of the components with selectable features of a building automation system. The features include type of actuation, controller type, temperature detection, piping configurations, valve types, fan types, pressure sensors, duct sensor, wiring options, and any other features for a building automation system. Information identifying the components of a building automation system is also stored in the database 108 with the component's engineering specifications, and its attributes and relations to particular features.

As shown in FIG. 1, the exemplary configurator 100 includes a design interface 104 and a mechanics interface 106. Using the design interface 104, a user such as a designer, may configure a system. The system is configured by providing responses to selections for features of a system desired to be configured. For example, a building automation system may be configured by selecting features of the system. Appropriate choices are presented to guide a user through the selection of an allowable configuration of devices and features such as mechanical equipment, control strategies, controllers, actuators, sensors, valves, dampers, detectors and/or installation methods. As the selections are made, components and other features of the system are identified, and a data set representing the selected components and/or features is populated. The data set is stored in the database 108 or any other storage medium.

The mechanics interface 222 processes and/or filters the data set using various data processing engines, methods, and/or processes to generate desired reports, diagrams, descriptions, programs, lists and estimates for a configured system. The mechanics interface 222 includes a computer aided drawing or design (CAD) engine to prepare schematic drawings for the configured system. The CAD engine generates a desired output or mechanical representation of the configured system. The CAD engine references the populated data set to access the data associated with the selected features and/or identified components of the configured system 100. The CAD engine may filter and/or process the data set to generate an iconic or graphic diagram of the configured system. The CAD engine may filter and/or process the data set to generate mechanical and/or electrical schematic drawings of the configured system or portion thereof.

The CAD engine determines groupings of related components of the configured system, and an associated drawing for each grouping. A size and/or arrangement of each grouping is determined and used to determine an arrangement and position of the groupings on one or more pages that minimizes space between groupings and thereby minimizes the number of pages for the schematic drawings of the configured system.

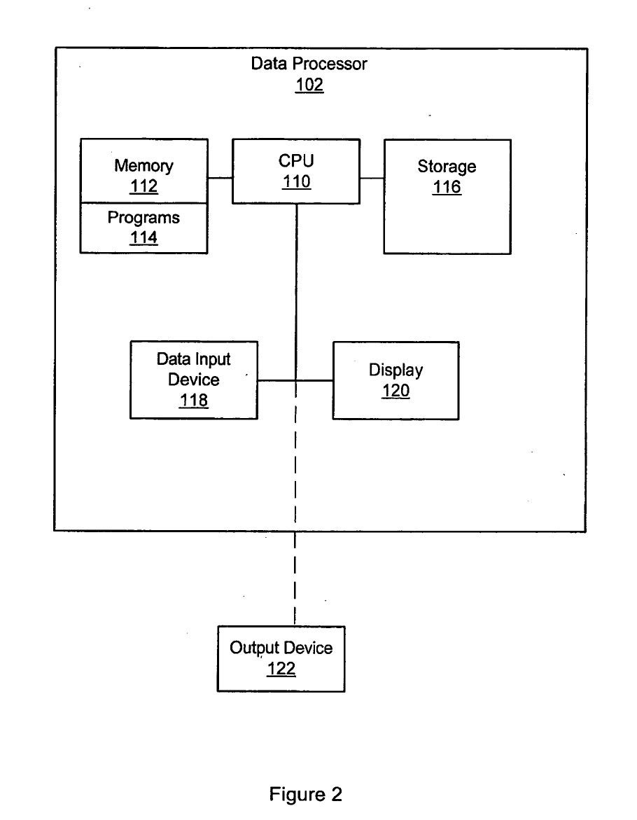

FIG. 2 illustrates an exemplary data processor 102 configured as a configurator 100 that generates schematic drawings having reduced empty-space between component groupings. The illustrated data processor 102 is provided for descriptive purposes and is not intended to limit the scope of the configurator or for an empty-space reduction of schematic drawings. The data processor 102 includes a central processing unit (CPU) 110, a memory 112, a storage device 116, a data input device 118, and a display 120. The processor 102 also may have an external output device 122, which may be another display or monitor, a printer or a communications port. A program 114 resides on the memory 112 and includes one or more sequences of executable code or coded instructions that are executed by the CPU 110. The program 114 is loaded into the memory 112 from storage device 116. The CPU 110 executes one or more sequences of instructions of the program 114 to process data. Data is input to the data processor 102 with data input device 118. The program 114 interfaces data input device 1118 for the input of data. Data processed by the data processor 102 is provided as an output to the display 120, external output device 122 (e.g., a printer, plotter, monitor, communication device and the like) and/or stored in the database 108. The data processor 102 may be configured to provide the functionality of the configurator 100. The processor 102 follows instructions of the program 114 in memory 112 to provide the features of the configurator 100, including generating schematic drawings for a configured system having a minimized white space.

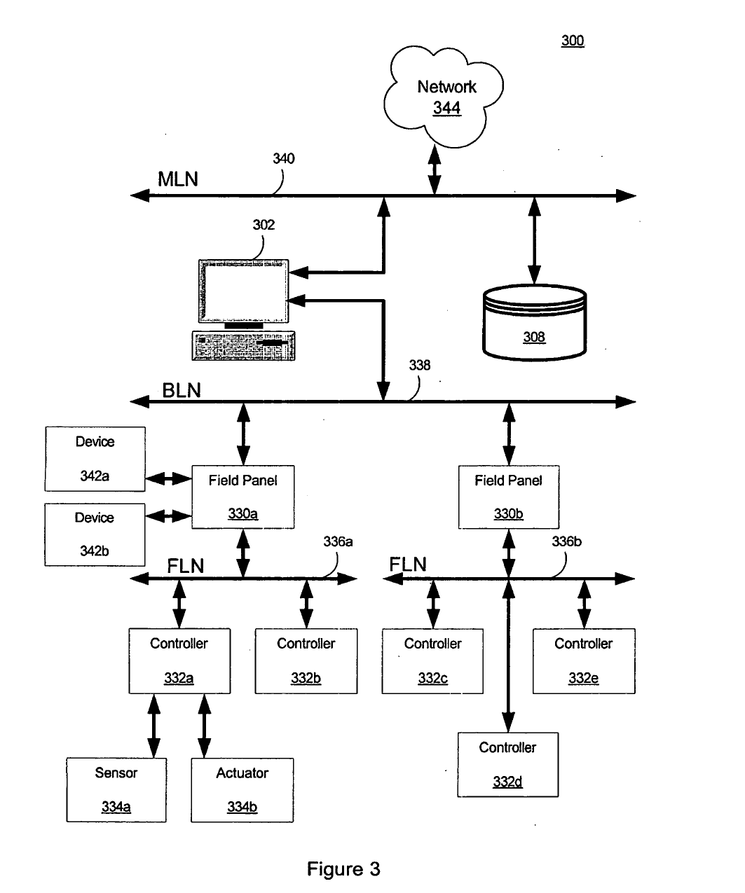

FIG. 3 illustrates a block diagram for an example of a system 300 that may be configured using the configurator 100. The illustrated system 300 is a building control system, and is provided only as an example of a type of system that may be configured. The configurator 100 is not limited to the illustrated building control system and may be used to configure, design and render any system 300.

The building control system 300 is a distributed control system that provides control functions for one or more building control operations. The types of building control systems include heating ventilation and air conditioning (HVAC), security, loss prevention, hazard detection and/or prevention, lighting, industrial control, combinations thereof, and the like. An example of a building control system is an APOGEE™ system provided by Siemens Building Technologies, Inc. of Buffalo Grove, Ill. The APOGEE™ system allows the setting and/or changing of various controls of the system.

The exemplary building control system 300 includes at least one supervisory control system or workstation 302, a system database 308, one or more field panels 330a, 330b, and one or more controllers 332a-332e. Each controller 332a-332e corresponds to an associated localized, standard building control subsystem. The building control subsystem may be a space temperature control subsystem, lighting control subsystem, hazard detection subsystem, security subsystem, combinations thereof, or the like. A controller for the building control subsystems may be, for example, a Terminal Equipment Controller (TEC) provided by Siemens Building Technologies, Inc. of Buffalo Grove, Ill.

To control an associated subsystem, each controller 332a-332e is coupled to one or more sensors 334a. The controllers 332a-332e also are operatively coupled to one or more actuators 334b. For example, sensor 334a and actuator 334b are coupled to the controller 332a. The controller 332a provides control functionality of each, one or both of the sensor 334a and actuator 334b.

A controller 332a controls a subsystem based on sensed conditions and desired set point conditions. The controller 332a controls the operation of one or more actuators to drive a condition sensed by a sensor 334a to a desired set point condition. The controller 332a is programmed with the set points and a code setting forth instructions that are executed by the controller for controlling the actuators to drive the sensed condition to the set point. For example, in an environmental control system that is controlled by controller 332a, the actuator 334b is operatively connected to an air conditioning damper. A sensor 334a may be a room temperature sensor that provides a feedback signal to the controller associated with a present temperature sensed by the sensor or associated with a relative temperature change. If the sensed temperature sensed by the sensor 334a exceeds a predetermined threshold, the controller provides a control signal to the actuator to open a damper, allowing air conditioning to flow into a room. Similarly, if the temperature sensor 334a detects a temperature drop below a lower threshold, then the controller 332a operates to close the damper, reducing flow of cool air in the room. The controller 332a will therefore attempt to bring the temperature within a range of set points or thresholds.

In the exemplary building control system 300, sensor, actuator, and set point information are shared among controller 332a-332e, the field panels 330a-330b, the work station 302, and any other components or elements that may affect control of the building control system 300. To facilitate sharing of information, groups of subsystems, such as those coupled to controllers 332a and 332b, are organized into floor level networks (“FLN's”) and generally interface the field panel 330a. The FLN data network 336a is a low-level data network that may use any suitable protocol. The protocol may be proprietary or open. Controllers 332c, 332d and 332e along with the field panel 330b are similarly coupled via a low-level FLN data network 336b. Any of a wide variety of FLN architectures may be used.

The field panels 330a and 330b are also coupled via a building level network (BLN) 338 to the workstation 302. The workstation 302 is a supervisory computer and is coupled to a database 308. The field panels 330a and 330b coordinate communication of data, information and signals between the controllers 332a-332e and the workstation 302 and database 308. In addition, one or more of the field panels 330a and 330b may have control programs for controlling actuators. For example, the field panels 330a and 330b are programmed to control HVAC actuators associated with air handlers and the like. The field panel 330a is operatively coupled to one or more HVAC system devices, shown for example as sensor 107a and actuator 107b.

The workstation 302 provides overall control and monitoring of the exemplary building control system 300 and includes a user interface. The workstation 302 further operates as a building control system data server that exchanges data with one or more components of the building control system 100. As a data server for the building control system 300, the workstation 302 can also exchange data with a database 308 and may also allow access to the building control system data by various applications. The applications are executed on the workstation 302 or other supervisory computers that may be communicatively coupled via a management level network (MLN) 340.

The workstation allows access to the components of the building control system 300, such as the field panels 330a and 330b. The workstation 302 also accepts modifications, changes, and alterations to the system. For example, a user may use the workstation 302 to reprogram set points for a subsystem via a user interface. The user interface may be an input device or combination of input devices, such as a keyboard, voice-activated response system, a mouse or similar device. The workstation 302 is operable to affect or change operations of the field panels 330a and 330b, utilize the data and/or instructions from the workstation 302 and/or provide control of connected devices, such as devices 342a and 342b and/or the controllers 332a and 332b.

The workstation 302 polls or queries the field panels 330a and 330b to gather data. The workstation 302 processes the data received from the field panels 330a and 330b, including maintaining a log of field panel events and/or logging thereof. Information and/or data are thus gathered from the field panels 330a and 330b in connection with the polling, query or otherwise, which the workstation 302 may store, log, and/or process. The field panels 330a and 330b therefore accept the modifications, changes, alterations and the like from the user.

The workstation 302 also maintains a database associated with each field panel 330a and 330b. The database maintains operational and configuration data for the association field panel. The MLN 340 is connected to other supervisory computers, servers, or gateways. For example, the MLN 340 may be coupled to a web server over a network 344 to communicate with external devices and other network managers. The MLN 340 may include an Ethernet or similar network. The MLN 340 may be configured to communicate according to known communication protocols such as TCP/IP, BACnet, and/or other communication protocols suitable for sharing large amounts of data.

The field panels 330a and 330b accept modification, changes, alterations, and the like from the user with respect to objects defined by the building control system 300. The objects are various parameters, control and/or set points, port modifications, terminal definitions, users, date/time data, alarms and/or alarm definitions, modes, and/or programming of the field panel itself, another field panel, and/or any controller in communication with a field panel.

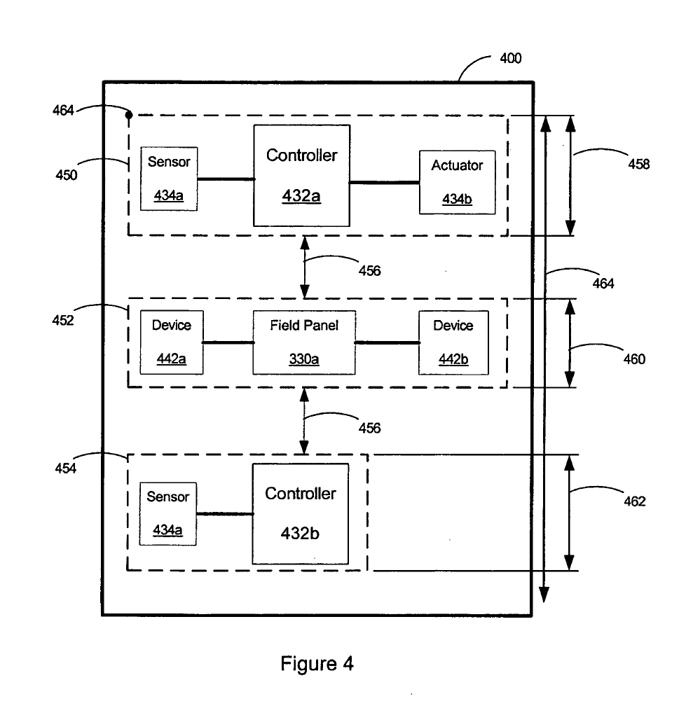

FIG. 4 illustrates an exemplary page of a compressed schematic diagram 400 of a configured system. The exemplary diagram 400 may be generated using any system or process for generating schematic diagrams such as the configurator 100 of FIG. 1. The exemplary page of the schematic diagram 400 illustrates three groupings 450, 452, 454 of components of an exemplary configured system. Although three groupings 450, 452, 454 are illustrated, the schematic diagram 400 may have other combinations and/or numbers of groupings.

A data set associated with parameters for the components, equipment, control strategies or other criteria is compiled based on the user-selected features for the configured system. The data set also includes data associated with a graphical representation and/or textual representation for each of the components, equipment, and devices of the configured system.

The data set is processed, or filtered, to organize the components, equipment, and/or devices into groupings of associated components. Data defining the parameters for each of the identified components, equipment, and/or devices for the configured system is filtered to identify associated or related components, devices and equipment. The associated components are identified as a grouping. For instance, a grouping may be identified as an air-handling unit and its associated damper, actuator and heating coil based on parameter data compiled according to the user selected features for the configured system. The grouping may include a field panel 330a and the devices 342a and 343b with which it is connected. The grouping may include a field panel 330b coupled with controllers 332c, 332d, and 332e. A grouping may include a portion of a building automation system, such as an FLN 336a, having controllers 332a and 332b and illustrating connections of controller 332a to sensor 334a and actuator 334b.

A rendering of the grouping in a schematic drawing may include collection of symbols, and/or icons graphically representing the components of the grouping. The exemplary compressed schematic diagram page 400 of FIG. 4 illustrates groupings 450, 452, 454 of associated components. Each grouping 450, 452, 454 represents an illustration each of the related components and illustrates the relationship between the components, such as by an electrical coupling between the components. The groupings 450, 452, 454 are configured, arranged, ordered and/or laid out according to the parameter data for the components of the groupings and data for associated with the configured system.

A first grouping 450 of associated components is identified based on processing the parameter data for the components of a configured system. The data associated with a graphical, or visual, representation of each of the associated components may be processed, or filtered, to determine an arrangement in a schematic drawing for the grouping 450 and/or define a relationship of the components with respect to each other in a rendering of the grouping. For example, from the data defining the parameters of the components of the first grouping 450 may be processed to determine that the rendering of the first grouping 450 illustrates a controller 432a coupled to an associated sensor 434a and an associated actuator 434b.

An order for the groupings relative to a page of the schematic diagram 400 is also determined according to the parameter data for the components of the configured system. For example, the parameter data may be processed to identify a hierarchy of each grouping. The groupings also may be ordered or arranged according to hierarchy, and/or engineering and schematic protocol for the configured system 100.

The first grouping 450 includes one or more associated components, including a controller 432a coupled to a sensor 434a and actuator 434a. The first grouping 450 may include other components. A second grouping 452 may be identified and includes other components of the system. The illustrated second grouping 452 includes a field panel coupled to devices 442a and 442b. The second grouping 452 may be identified based on the parameter data for the components of the second grouping 452 so that is located adjacent to the first grouping 450. Other groupings may also be identified, for example, the exemplary third grouping 454, which includes yet further components such as controller 432b coupled to sensor 434a. Alternatively, or additionally, the groupings 450, 452, 454 may have different levels of hierarchy, and order for the groupings on the schematic drawing 400.

A size of each grouping 450, 452, 454 is determined. The size may be a span of the grouping relative to a length-wise dimension 464 for the page of the schematic drawing 400. For each component of the grouping, a size of a rendering of the component relative to a length-wise dimension of a page of the schematic drawing may be known or determined based on the parameter data for the components. The span for the grouping may be determined based on the largest dimension along the length-wise dimension for each of the renderings of the components of the grouping. The first grouping 450 has a span or vertical length 458 that is determined based on the largest dimension for each of the illustrated components of the grouping 450. The second grouping has a span 460, and the third grouping has a span 462 along the length 464 of the page 400. The components of the group are laid out in a width-wise or horizontal dimension within each group according to the parameter data for the grouping and/or schematic protocol. The size of the grouping also may be scaled according to a user selection, the parameter data and/or schematic protocol.

The groupings 450, 452, 454 are arranged or plotted on the page 400 so that adjacent groupings are separated by a predetermined spacing 456. The predetermined spacing 456 is identified to minimize a total number of pages to depict each grouping 450, 452, 454 for the configured system. The first grouping 450 is positioned on the page 400 at a page origin 464. The first grouping 450 is aligned so that an origin of the grouping coincides with the origin of the page 464.

An adjacent grouping, such as the second grouping 452, is located the predetermined spacing 456 away from the first grouping 450. For example, the second grouping 452 is located on the page 400 so that an origin for the second grouping 452 is at a distance from the origin 464 of the page 400 that is substantially equal to the span 458 of the first grouping 450 and the predetermined spacing 456. The third grouping 454 is located on the page 400 so that an origin for the third grouping 454 is at a distance from the origin 464 of the page 400 that is substantially equal to the span 458 of the first grouping 450, the predetermined spacing 456 between the first and second groupings 450, 452 and the predetermined spacing 456 from the second grouping 452.

The page 400 is populated with renderings of subsequent groupings where each grouping is located and aligned on the page at a location that is a distance away from the origin 464 that is at least the total of the span of each grouping previously located on the page and a number of predetermined spacings equal to the number of previously located groupings. The page 400 is populated until it is determined that there is not sufficient space on a page for a grouping, when a new page is rendered. If a grouping to be positioned has a span that is greater than an amount of space on a page 400 beyond a predetermined distance from a grouping previously positioned on the page 400, the grouping will be located at an origin of a new schematic page. The renderings of the groupings are arranged on a schematic page according to the determined size of each grouping so that adjacent groupings on the schematic drawing page are separated by a predetermined spacing. The arranged page 400 may be provided to an output device such as a video display or monitor or a printer.

The predetermined spacing 456 provides a distance between adjacent groupings that minimizes empty space between groupings and thereby reducing a total number of pages for a schematic drawing for a configured system. In an embodiment, the predetermined spacing 456 may be defined to limit a total number of pages to two pages.

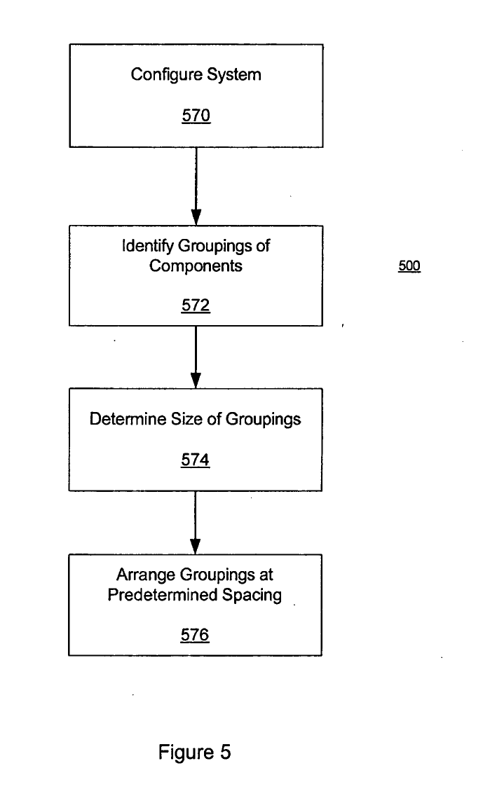

FIG. 5 illustrates a block diagram flowchart for a method for compressing a schematic drawing. The method includes configuring 570 a system for which a schematic drawing is to be prepared. The configured system may include multiple components. As a result of configuring the system, a data set is generated representing parameters of the components of the system. The data set is associated with parameters and features of the components.

The method also includes identifying 572 groupings of associated components. The groupings may be identified by filtering the data associated with the components to identify relationships between components. The size of each grouping is also determined 574. The size may be determined relative to a page of the schematic drawing. The size may be a span of the grouping along a dimension of the page. Based on the determined size of each grouping and the parameter data, the groupings are arranged 576. The groupings are arranged 576 so that adjacent groupings are spaced a predetermined distance. After being laid out, the page of the schematic drawing may be provided to an output device, such as a video monitor or printer.

While the invention has been described above by reference to various embodiments, it should be understood that many changes and modifications can be made without departing from the scope of the invention. For example, the configurator and its components are adapted for configuring industrial control equipment. Applying engineering principles for the industrial control equipment, a configuration schema may be developed whereby a predetermined set of rules may be followed to guide a designer of an industrial control system through selectable features to a configured industrial control system. Similarly, the configuration may be adapted to configure security and lighting systems. The configurator may be adapted to configure integrated systems where, for example, an environmental control system may be configured with a fire detection and prevention system for a building.

The description and illustrations are by way of example only. Many more embodiments and implementations are possible within the scope of this invention and will be apparent to those of ordinary skill in the art. In an embodiment, the configurator includes an autoCAD engine that generates an electrical schematic that illustrates electrical relationships for the components of the system. The electrical schematic may be, for example, a CAD drawing showing electrical connections of the electrical components of the configured system. The various embodiments are not limited to the described environments, and have a wide variety of applications including integrated building control systems, environmental control, security detection, communications, industrial control, power distribution, and hazard reporting.

It is intended in the appended claims to cover all such changes and modifications which fall within the true spirit and scope of the invention. Therefore, the invention is not limited to the specific details, representative embodiments, and illustrated examples in this description. Accordingly, the invention is not to be restricted except in light as necessitated by the accompanying claims and their equivalents.

I claim:

1. A method for generating a schematic drawing, the method comprising:
(a) obtaining a data set associated with a configured system, the data set associated with components of the configured system;
(b) filtering the data set to identify groupings of associated components of the configured system;
(c) determining a size of a rendering of each grouping relative to a schematic drawing page;
(d) arranging the rendering of each grouping according to the determined size of each grouping so that adjacent groupings on the schematic drawing page are separated by a predetermined maximum spacing; and
(e) rendering the schematic drawing page having a plurality of groupings separated by the predetermined spacing.

2. The method of claim 1 further comprising rendering the schematic drawing page on a graphic user interface.

3. The method of claim 1 further comprising printing the schematic drawing page.

4. The method of claim 1 where the predetermined spacing is defined to minimize a total number of schematic drawing pages for the configured system.

5. The method of claim 4 where the predetermined spacing is defined to minimize the total number of schematic drawing pages to a maximum of two schematic drawing pages.

6. The method of claim 1 wherein the schematic drawing page of the configured building automation system comprises an electrical schematic diagram.

7. The method of claim 6 wherein the configured system comprises a building automation system.

8. A method for compressing an auto-generated drawing comprising:
identifying groupings of associated components of a configured system;
configuring a layout for each grouping according to a relationship of associated components;
determining a linear span of the layout for each grouping relative to a length-wise dimension of a page of schematic drawing; and
plotting the schematic drawing according to the determined linear span for each grouping, where adjacent groupings are spaced a predetermined distance on the page of a schematic drawing.

9. The method of claim 8 further comprising arranging the components of each grouping on the page of the schematic drawing according to parameters defining a relative arrangement of the components.

10. The method of claim 8 further comprising ordering the groupings on the page of the schematic drawing according to parameters defining a relative order of the groupings of components on the schematic drawing.

11. The method of claim 10 further comprising limiting a number of groupings for the page of the schematic drawing according to the linear span of each ordered grouping and predetermined spacing between adjacent ordered groupings.

12. The method of claim 11 further comprising rendering a new page of the schematic drawing in response to a determination that a span for an ordered grouping is greater than a remaining length-wise dimension of the page of the schematic drawing.

13. The method of claim 8 wherein the configured system is a building automation system.

14. The method of claim 13 wherein the schematic drawing is an electrical schematic associated with electrical components of the building automation system.

15. A computer-readable medium having computer-executable instructions thereon which, when executed on one or more processors of a digital computing device, direct the device to execute a method comprising:
determining a size of a rendering of each of a plurality of groupings of a system relative to a schematic drawing page;
arranging the rendering of each grouping according to the determined size of each grouping so that adjacent groupings on the schematic drawing page are separated by a predetermined spacing; and
rendering the schematic drawing page having a plurality of groupings separated by the predetermined spacing.

16. The computer-readable medium of claim 15 where the executed method further comprises rendering the schematic drawing page on a graphic user interface.

17. The computer-readable medium of claim 15 where the schematic drawing page of the configured building automation system comprises an electrical schematic diagram.

18. The computer-readable medium of claim 17 wherein the configured system comprises a building automation system.

19. The computer-readable medium of claim 18 wherein the an electrical schematic diagram comprises two pages.

20. The computer-readable medium of claim 15 further comprising rendering a new page of the schematic drawing in response to a determination that the size for a rendering of a grouping is greater than a remaining a remaining space of the page of the schematic drawing.

21. A method for rendering a schematic representation for a building automation system, the method comprising:
(a) selecting a building automation system to configure using a configuration engine;
(c) designing the system using the configuration engine, the configuration engine being driven according to engineering parameters for the selected building automation system; and
(c) generating a mechanical representation of the designed building automation system using the configuration engine, the mechanical representation including an electrical schematic diagram illustrating electrical components of the configured system being laid out according ordered groupings of associated components where adjacent groupings are spaced a predetermined distance, where the groupings and arrangement the groupings is determined according to the engeering parameters of the selected building automation system.
